(19) United States
(12) Patent Application Publication
(10) Pub. No.: US 2016/0234545 A1
(43) Pub. Date: Aug. 11, 2016

(54) ELECTRONIC DEVICE, METHOD AND STORAGE MEDIUM

(71) Applicants: KABUSHIKI KAISHA TOSHIBA, Tokyo (JP); Toshiba Lifestyle Products & Services Corporation, Tokyo (JP)

(72) Inventors: Munehiro TOKIKURA, Kawasaki Kanagawa (JP); Yosuke TAKAHASHI, Kokubunji Tokyo (JP); Naoki ESAKA, Kawasaki Kanagawa (JP); Masakazu SUZUKI, Kumagaya Saitama (JP)

(21) Appl. No.: 14/878,559

(22) Filed: Oct. 8, 2015

(30) Foreign Application Priority Data
Feb. 6, 2015 (JP) 2015-022227

(51) Int. Cl. H04N 21/431; H04N 21/482; H04N 21/472; H04N 21/41

(52) U.S. Cl. CPC H04N 21/4314; H04N 21/4126; H04N 21/4318; H04N 21/4821; H04N 21/47205; H04N 21/47214

(57) ABSTRACT

According to one embodiment, an electronic device includes a processor. The processor switches a first program guide on a display to a second program guide. The first program guide includes a plurality of first objects related to a plurality of programs on the first channel. The second program guide includes a plurality of second objects related to a plurality of programs on the second channel. When the second program guide is displayed and when one of the plurality of first objects is selected from the first program guide, at least one of the plurality of programs on the second channel in the second program guide including a broadcast time that overlaps a broadcast time of a program corresponding to the selected first object is displayed visually differently.

### CROSS-REFERENCE TO RELATED APPLICATIONS

This application is based upon and claims the benefit of priority from Japanese Patent Application No. 2015-022227, filed Feb. 6, 2015, the entire contents of which are incorporated herein by reference.

### FIELD

Embodiments described herein relate generally to an electronic device, a method and a storage medium.

### BACKGROUND

In recent years, various battery-powered portable electronic devices such as tablets and smartphones have become widespread. Such electronic devices comprise a touchscreen display that permits a touch operation on the screen. In addition, such electronic devices comprise a communication function to access the Internet as a basic function. Therefore, the user carrying such an electronic device can acquire and view various types of information via the Internet while on the go.

On a television receiver, a recorder, etc., a graphical user interface (GUI) to search television broadcast programs is generally provided. Typically, the GUI assists the user by displaying a broadcast schedule of television broadcast programs (program guide) and information related to television broadcast programs. If a tablet, a smartphone, etc., comprise a function of acquiring the program guide to television broadcast programs and the information related to television broadcast programs and providing such a GUI by the above-described communication function, the user can search television broadcast programs by use of the tablet, the smartphone, etc. In addition, if the tablet, the smartphone, etc., comprising a touchscreen display serve as remote controllers of a television receiver, a recorder, etc., convenience of viewing and recording of television broadcast programs can be improved.

For example, if a program guide to television broadcast programs is displayed in the form like radio and TV listings of a newspaper on a smartphone comprising a relatively small screen, visibility may be deteriorated since a text size is decreased and a program comprising a short broadcast duration of, for example, five minutes, becomes difficult to display.

The visibility may be maintained by adjusting the display size by operations called pinching in and pinching out on the touchscreen display. Pinching in is a gesture of decreasing the interval between two digits in contact the touchscreen display (i.e., closing the digits). Pinching out is a gesture of increasing the interval between two digits in contact with the touchscreen display (i.e., opening the digits). Since the broadcast duration varies according to programs, however, operations such as pinching in and pinching out must be frequently performed to display information related to a target program in an optimal size.

For the aforementioned reasons, a method of displaying program information of a channel on the screen in the list form by, for example, optimizing the display size of each program according to the broadcast duration, and switching a channel to be displayed by operation called a swipe is applied. A swipe is a gesture of moving the digit in contact with the touchscreen display in an arbitrary direction. In this method, however, it is difficult to confirm a program on a different channel temporally overlapping a program on a channel that the user has focused on, and to confirm whether a program whose recording has been already reserved (and whose air time overlaps the air time of the focused program) is present on a different channel.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing the appearance of an electronic device of a first embodiment.

FIG. 2 is an exemplary diagram showing an example of a use situation of the electronic device of the first embodiment.

FIG. 3 is an exemplary diagram showing a system configuration of the electronic device of the first embodiment.

FIG. 4 is an exemplary diagram showing a functional block of a program information display application program which operates on the electronic device of the first embodiment.

FIG. 5 is an exemplary illustration showing an example of a basic screen output by the OS which operates on the electronic device of the first embodiment.

FIG. 6 is an exemplary illustration showing an example of a top screen displayed by the program information display application program which operates on the electronic device of the first embodiment.

FIG. 7 is an exemplary illustration showing an example of a program guide to television broadcast programs displayed by the program information display application program which operates on the electronic device of the first embodiment.

FIG. 8 is an exemplary first illustration showing an original GUI provided by the program information display application program which operates on the electronic device of the first embodiment.

FIG. 9 is an exemplary second illustration showing the original GUI provided by the program information display application program which operates on the electronic device of the first embodiment.

FIG. 10 is an exemplary illustration showing a modified example of the original GUI provided by the program information display application program which operates on the electronic device of the first embodiment.

FIG. 11 is an exemplary flowchart showing an operating procedure of the program information display application program which operates on the electronic device of the first embodiment.

FIG. 12 is an exemplary diagram showing an example of a use situation of an electronic device of a second embodiment.

FIG. 13 is an exemplary diagram showing a functional block of a program information display application program which operates on the electronic device of the second embodiment.

FIG. 14 is an exemplary illustration showing an example of a program guide to television broadcast programs displayed by the program information display application program which operates on the electronic device of the second embodiment.

FIG. 15 is an exemplary flowchart showing an operating procedure of the program information display application program which operates on the electronic device of the second embodiment.

FIG. 16 is an exemplary illustration showing an original GUI provided by a program information display application program which operates on an electronic device of a third embodiment.

FIG. 17 is an exemplary flowchart showing an operating procedure of the program information display application program which operates on the electronic device of the third embodiment.

### DETAILED DESCRIPTION

Various embodiments will be described hereinafter with reference to the accompanying drawings.

In general, according to one embodiment, an electronic device includes a display, a receiver and a processor. The receiver is configured to receive information related to programs on at least two channels. The processor is configured to switch a first program guide displayed on the display to a second program guide. The first program guide including a plurality of first objects. The second program guide including a plurality of second objects. The plurality of first objects comprises information related to a plurality of programs on the first channel, and a display size of the plurality of first objects is based on broadcast durations of the plurality of programs on the first channel. The plurality of second objects comprises information related to a plurality of programs on the second channel, and a display size of the plurality of second objects is based on broadcast durations of the plurality of programs on the second channel. The display size of at least one of the plurality of first objects differs from the display size of at least one of the plurality of second objects for the same broadcast duration. When the second program guide is displayed and when one of the plurality of first objects is selected from the first program guide, at least one of the plurality of programs on the second channel in the second program guide comprising a broadcast time that overlaps a broadcast time of a program corresponding to the selected first object is displayed visually differently.

### First Embodiment

First, a first embodiment is described.

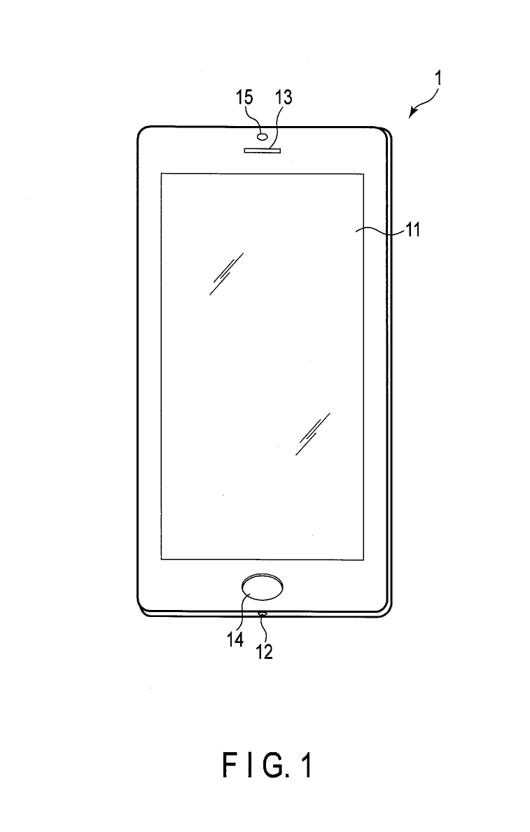

FIG. 1 is an exemplary illustration showing the appearance of an electronic device of the present embodiment. The electronic device is implemented as, for example, a smartphone. As shown in FIG. 1, an electronic device 1 has a thin plate-like housing. A touchscreen display 11 is located at the center of the front surface of the housing. The user can give an operation instruction to the electronic device 1 by performing a touch operation on the touchscreen display 11.

A microphone 12 for audio input is located at the center of the lower surface of the housing. A speaker 13 for audio output is located on the periphery of the touchscreen display 11 on the front surface of the housing. An operating portion 14 to give an operation instruction to the electronic device 1 and a camera 15 to capture an image are also located on the periphery of the touchscreen display 11. The camera 15 is also located on the back surface of the housing (not shown in FIG. 1). For example, a power switch to power on and off the electronic device 1, a volume switch to adjust the volume of the speaker 13, etc., are located on the side surface of the housing (not shown in FIG. 1).

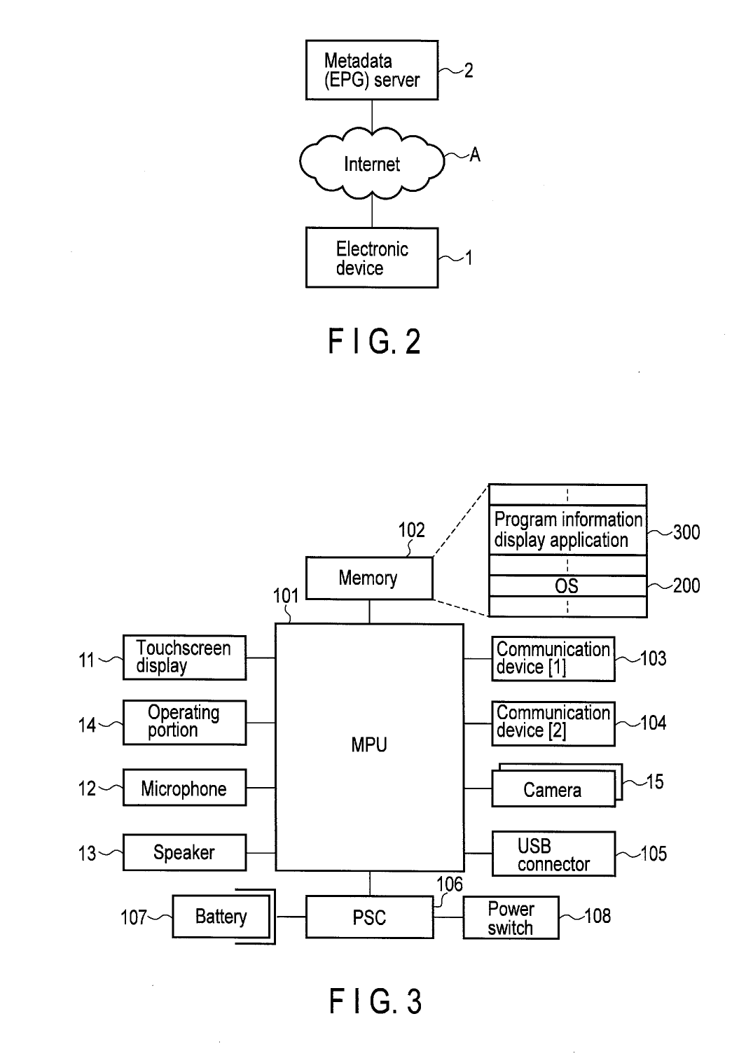

FIG. 2 is an exemplary diagram showing an example of a use situation of the electronic device 1 in the present embodiment.

The electronic device 1 comprises a communication function to access the Internet A and acquires metadata (electronic program guide [EPG] data) from a metadata server 2 via the Internet A. The electronic device 1 provides a GUI that displays a program guide to television broadcast programs and information related to television broadcast programs on the touchscreen display 11 by using the acquired metadata. As described above, the electronic device 1 is implemented as, for example, a smartphone. The touchscreen display 11 mounted on the electronic device 1 implemented as a smartphone inevitably comprises a relatively small screen. So, the electronic device 1 is configured to display a visually recognizable program guide on the relatively small screen. The program guide displayed by the electronic device 1 is not limited to a program guide to television broadcast programs, but may be, for example, a program guide to radio broadcasts.

FIG. 3 is an exemplary diagram showing a system configuration of the electronic device 1.

In addition to the touchscreen display 11, the microphone 12, the speaker 13, the operating portion 14 and the camera 15 shown in FIG. 1, the electronic device 1 further comprises a micro processing unit (MPU) 101, a memory 102, a communication device [1] 103, a communication device [2] 104, a universal serial bus (USB) connector 105, a power supply controller (PSC) 106, a battery 107, a power switch 108, etc., as shown in FIG. 3. The battery 107 is housed in the housing of the electronic device 1 so as to be detachable.

The MPU 101 is a processor that controls operations of the electronic device 1. The MPU 101 executes various programs such as the operating system (OS) 200 and a program information display application program 300 to be described later which are stored in the memory 102. The MPU 101 is equipped with a graphics controller that displays an image on the touchscreen display 11. The MPU 101 is also equipped with an input controller to accept a touch operation on the touchscreen display 11 or an operation of the operating portion 14. A display screen of each program executed by the MPU 101 is displayed on the touchscreen display 11. If a touch operation on the touchscreen display 11 or an operation of the operating portion 14 is performed in the display screen, information related to the performed operation is supplied to the program outputting the display screen.

The MPU 101 is further equipped with a sound controller that executes audio processing for audio input from the microphone 12 and audio output to the speaker 13.

The communication device [1] 103 is a communication module that communicates with external devices including the metadata server 2 via the Internet A. The communication device [2] 104 is a communication module that communicates with external devices around the electronic device 1 such as a television receiver and a recorder. The electronic device 1 further comprises a communication module that performs communication for telephone call (not shown in FIG. 3). All or a part of these communication functions may be built in the MPU 101.

The USB connector 105 is a connector to which a USB device (or a USB cable) can be connected. The MPU 101 is equipped with a USB controller that communicates with the USB device connected via the USB connector 105. The power can be input to the electronic device 1 via the USB connector 105. The power input from the USB connector 105 is supplied to the PSC 106.

The PSC 106 performs power management of the electronic device 1. The PSC 106 performs control to supply the power from the battery 107 to various components in the electronic device 1. If the power is input from the USB connector 105, the PSC 106 supplies the power input from the USB connector 105 to various components in the electronic device 1. The PSC 106 also comprises a function of charging the battery 107 using the power input from the USB connector 105. The PSC 106 further comprises a function of powering on and off the electronic device 1 in response to an operation of the power switch 108.

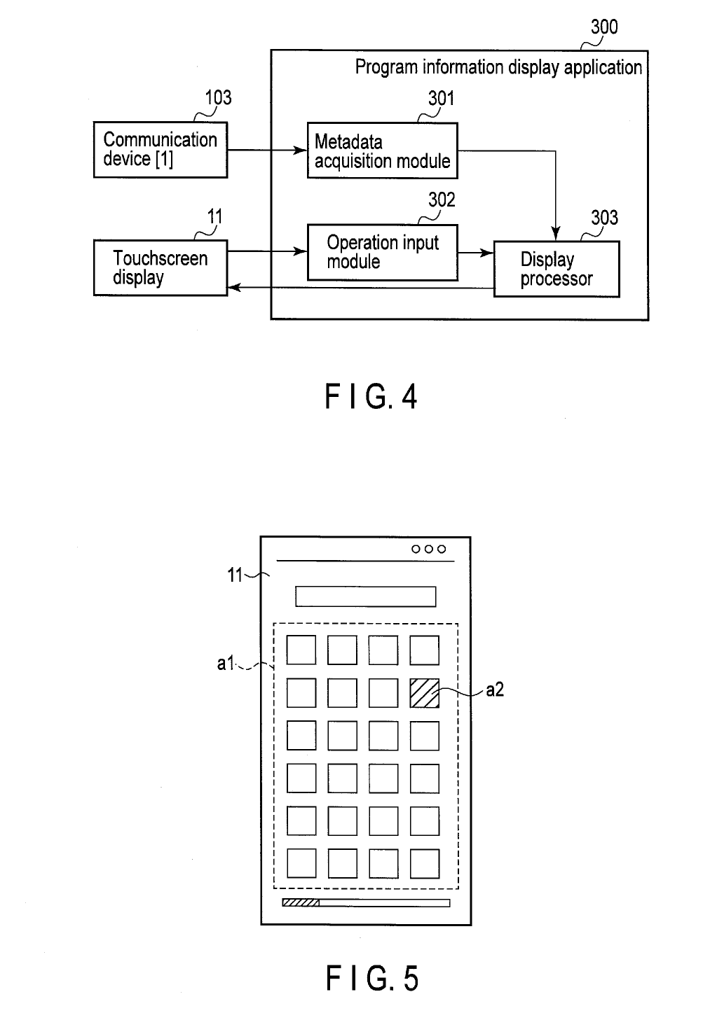

FIG. 4 is an exemplary diagram showing a functional block of the program information display application program 300 which operates on the electronic device 1 of the present embodiment.

As shown in FIG. 4, the program information display application program 300 comprises a metadata acquisition module 301, an operation input module 302 and a display processor 303. It should be noted that the program information display application program 300 is a program that operates under the control of the OS 200 and that transmission and reception of data between the program information display application program 300 and the communication device [1] 103 or the touchscreen display 11 shown in FIG. 4 are performed via the OS 200.

The metadata acquisition module 301 is a module that acquires metadata from the metadata server 2. The operation input module 302 is a module that inputs information related to a touch operation performed on the touchscreen display 11. The display processor 303 is a module that visually recognizably displays a program guide to, for example, television broadcast programs, on the relatively small screen (touchscreen display 11) by using the metadata acquired by the metadata acquisition module 301 and the information related to the touch operation input by the operation input module 302.

As described above, the program information display application program 300 is a program that operates under the control of the OS 200. For example, if the electronic device 1 is powered on by the operation of the power switch 108, a basic screen output by the OS 200 is displayed on the touchscreen display 11 as shown in FIG. 5.

An area a1 is provided on the basic screen such that icons for various application programs including the program information display application program 300 are arranged thereon. The user can activate a target application program or bring the target application program into an active state by performing an operation called a tap on an icon for the target application program on the touchscreen display 11. A tap is a gesture of lifting the digit in contact with the touchscreen display 11 in a direction approximately orthogonal to the display surface of the touchscreen display 11. A tap having a time of contact between the digit and the touchscreen display 11 exceeding a threshold value is often called a long tap. Bringing the application program into the active state means displaying, on the touchscreen display 11, a display screen of the application program which has been already activated and is operating in the background.

In FIG. 5, an icon a2 is assumed to be an icon for the program information display application program 300. That is, the user can activate the program information display application program 300 or bring the program information display application program 300 into the active state by tapping the icon a2. For example, when the program information display application program 300 is activated, the display processor 303 of the program information display application program 300 first displays a top screen to show the user a plurality of menu items.

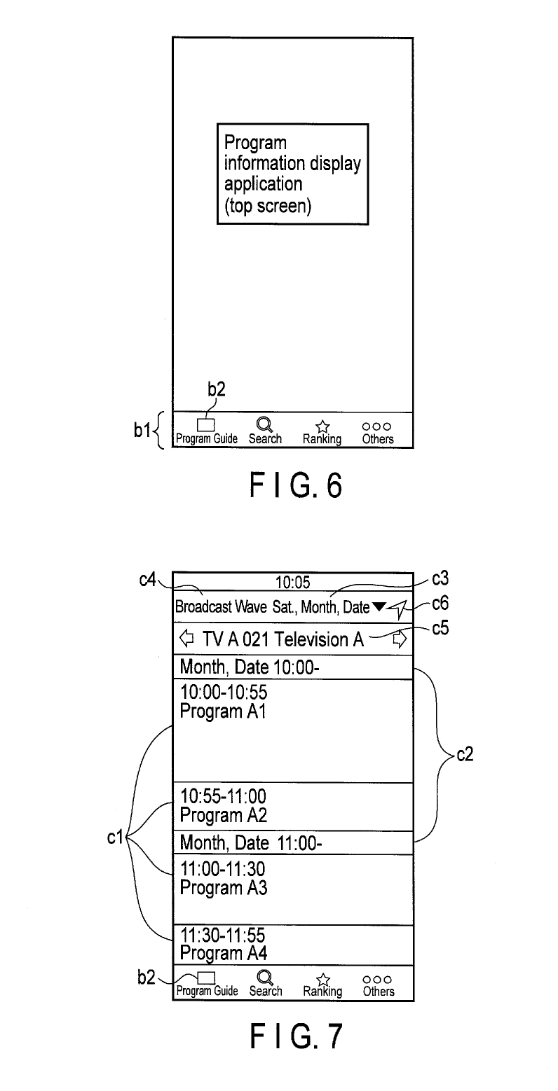

FIG. 6 is an exemplary illustration showing an example of the top screen displayed by the program information display application program 300.

A menu area b1 is provided on the top screen. In the menu area b1, the menu items “Program Guide” (indicated by b2), “Search”, “Ranking” and “Others” are displayed. The user allows a program guide to television broadcast programs to be displayed on the touchscreen display 11 by giving a tap to select “Program Guide”. If “Search” is selected, for example, a screen to search a program by a keyword can be displayed. If “Ranking” is selected, for example, a screen on which the most popular programs are listed by category can be displayed. If “Others” is selected, other menus that are not displayed in the menu area b1 due to space limitation when the top screen is first displayed can be displayed.

It is hereinafter assumed that “Program Guide” is selected. The program information display application program 300 recognizes that “Program Guide” is selected, based on the information related to the touch operation input by the operation input module 302. If “Program Guide” is selected, the metadata acquisition module 301 first executes processing for acquiring metadata from the metadata server 2. Second, the display processor 303 executes processing for displaying a program guide using the metadata acquired by the metadata acquisition module 301. The metadata acquisition module 301 may acquire the metadata when the program information display application program 300 is activated or brought into the active state, or acquire the metadata periodically while the program information display application program 300 is operating in the background.

FIG. 7 is an exemplary illustration showing an example of the program guide to television broadcast programs displayed by the program information display application program 300.

As shown in FIG. 7, the display processor 303 displays a program guide in a list form in which program information (air times, titles, etc.) of a channel is arranged in the longitudinal direction on a time-series basis. A display size (in the longitudinal direction) of each object c1 expressing a program is determined according to a broadcast duration. In the example illustrated, a display size of an object c1 expressing a program A1 having a broadcast duration of fifty five minutes is different from a display size of an object c1 expressing a program A2 having a broadcast duration of five minutes. If a display size is assigned per unit time at a constant rate, for example, it becomes difficult to display a program having a short broadcast duration of, for example, five minutes, such as the program A2. Conversely, if a display size of each program is constant regardless of a broadcast duration, for example, in a case where a large number of programs each having a short broadcast duration are concentrated in a certain period, the ratio of a display size of this period to the whole size becomes enormous. The program information can be displayed in a balanced manner by varying the display size of each object c1 according to a broadcast duration.

Varying the display size of each object c1 means that the time axis is stretchable. Therefore, the display processor 303 inserts an object c2 expressing the hour between the objects c1. The object c2 shows the user the time only as a guide, and is not necessarily inserted every hour or inserted in a position corresponding to the hour in the program guide. For example, if a program is scheduled to be broadcast from 17:45 to 20:45, objects c2 expressing 18:00 and 19:00 are not displayed but an object c2 expressing 20:00 is displayed between an object c1 expressing the program and an object c1 expressing the next program, i.e., at a position of 20:45.

A channel whose program guide is first displayed when “Program Guide” is selected on the top screen shown in FIG. 6 may be the first channel in the order of channel number or may be a channel whose program guide was last displayed.

If the information related to the touch operation input by the operation input module 302 indicates a swipe in the vertical direction (longitudinal direction), the display processor 303 vertically scrolls the program guide to move the period to be displayed. In contrast, if the information related to the touch operation input by the operation input module 302 indicates a swipe in the horizontal direction (lateral direction), the display processor 303 switches the displayed program guide to a program guide for a different channel. The user can confirm programs on an arbitrary channel and in an arbitrary period by swiping the screen vertically and horizontally.

The date of the program guide can be changed by tapping a display area c3 of the date. The program guide to be displayed can be switched between digital terrestrial broadcasting, BS digital broadcasting, CS digital broadcasting, etc., by tapping a display area c4 of the character string “Broadcast Wave”.

A name of a channel (broadcast station) of the displayed program guide is displayed in an area c5. A list of channels whose program guides can be displayed can be displayed by tapping the display area c5, and the displayed channel can be switched to an arbitrary channel by selecting one of the channels by giving a tap. When the user views a future program in the program guide and a current program is scrolled out of the screen, the current program can be displayed again without repeating vertical scrolling by tapping a button c6.

It is assumed that the user is considering which program to watch at home by using the electronic device 1, for example, while returning home by train. In such a case, after focusing on a program of a channel, the user often wants to confirm a program (competitive program) scheduled to be broadcast on a different channel in the same period as the program that the user has focused on. If a program guide is displayed on the screen per channel, however, it is difficult to confirm the competitive program. In particular, if a display size of each object is variable according to a broadcast duration in order to display the program information in a balanced manner, the competitive program becomes more difficult to confirm. This is because, if the user focuses on a program of a channel and then switches the displayed program guide to a program guide for a different channel by horizontally swiping the screen, the air time of a program expressed by an object located, after the switching, at the same position as an object expressing the program that the user has focused on does not necessarily correspond to the air time of the program that the user has focused on.

Therefore, the program information display application program 300 provides an original GUI improved with respect to the display of the program guide as described below in detail.

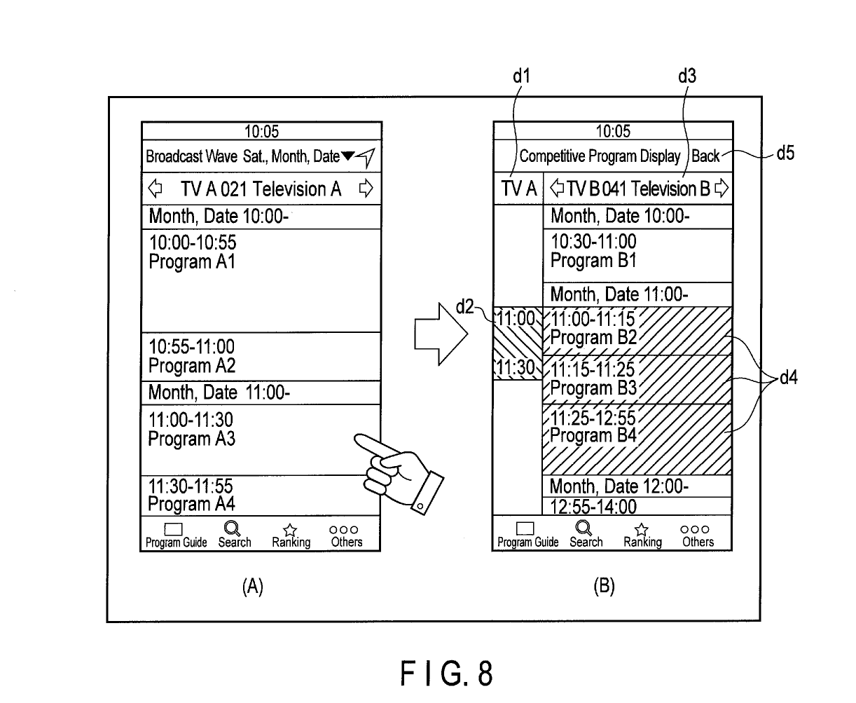

FIG. 8 is an exemplary first illustration showing the original GUI provided by the program information display application program 300 of the present embodiment.

In FIG. 8, (A) shows a situation where the program guide is in a normal display. It is assumed that the user viewing the program guide focuses on a program A3 in the program guide and wants to confirm a program scheduled to be broadcast on a different channel in the same period as the program A3. In such a case, the user performs a specified operation such as a long tap on an object expressing the program A3. The specified operation is assumed to be a long tap.

If the information related to the touch operation input by the operation input module 302 indicates a long tap on an object expressing any program in the program guide, the display processor 303 switches the normal display to an overlapping program confirmation display. (B) shows a situation where the program guide is in the overlapping program confirmation display.

As shown in FIG. 8 (B), in the overlapping program confirmation display, the display processor 303 first displays, for example, in the left periphery of the screen, a simplified program guide for the channel on which the program (focused program) expressed by the long-tapped object is scheduled to be broadcast. The simplified program guide indicates at least the air time of the focused program. In FIG. 8, a program guide d1 is the simplified program guide. An object d2 is provided to indicate the air time of the focused program. For example, the object d2 may be located at the center of the simplified program guide d1 regardless of the position of the object expressing the focused program in the normal display.

The display processor 303 also displays, in a blank space (other than the portion on which the simplified program guide d1 is displayed) on the screen, a program guide for a channel different from the channel on which the focused program is scheduled to be broadcast. The different channel may be determined, for example, in the order of channel number. The program guide for the different channel is displayed in a list form similar to the normal display (except that the display size in the horizontal direction is reduced). In FIG. 8, a program guide d3 is the program guide for the different channel. The display processor 303 allows an object expressing a program, which is scheduled to be broadcast on the different channel and has an air time overlapping the air time of the focused program, to be visually distinguishable by, for example, color coding. In FIG. 8, programs B2, B3 and B4 expressed by objects d4 are programs each having an air time overlapping the air time of the focused program A3. These programs are indicated by a color different from a color of a program B1 having an air time not overlapping the air time of the focused program A3.

For example, the programs B2 and B3 each having an air time entirely overlapping that of the focused program A3 may be further visually distinguishable from the program B4 having an air time partly overlapping that of the focused program A3 by, for example, color coding. When the air time of a program partly overlaps that of the focused program, there are two cases, i.e., a case where only the beginning of the program overlaps the focused program and a case where only the end of the program overlaps the focused program. Therefore, these two cases may be further visually distinguishable from each other by, for example, color coding. A method for making an object expressing a program having an air time overlapping that of the focused program visually distinguishable is not limited to the color coding, but various methods such as the placing of a mark can also be applied.

If the user wants to return the overlapping program confirmation display to the normal display, the user only have to tap a display area d5 of the character string “Back”.

Next, it is assumed that a vertical or horizontal swipe is performed while the program guide is in the overlapping program confirmation display.

If the information related to the touch operation input by the operation input module 302 indicates a vertical swipe, the display processor 303 vertically scrolls only the program guide for the different channel displayed adjacent to the simplified program guide for the channel on which the focused program is scheduled to be broadcast. In contrast, if the information related to the touch operation input by the operation input module 302 indicates a horizontal swipe, the display processor 303 switches the program guide for the different channel displayed adjacent to the simplified program guide for the channel on which the focused program is scheduled to be broadcast to a program guide for a further different channel. That is, in the overlapping program confirmation display, the simplified program guide for the channel on which the focused program is scheduled to be broadcast is fixed to the left periphery of the screen.

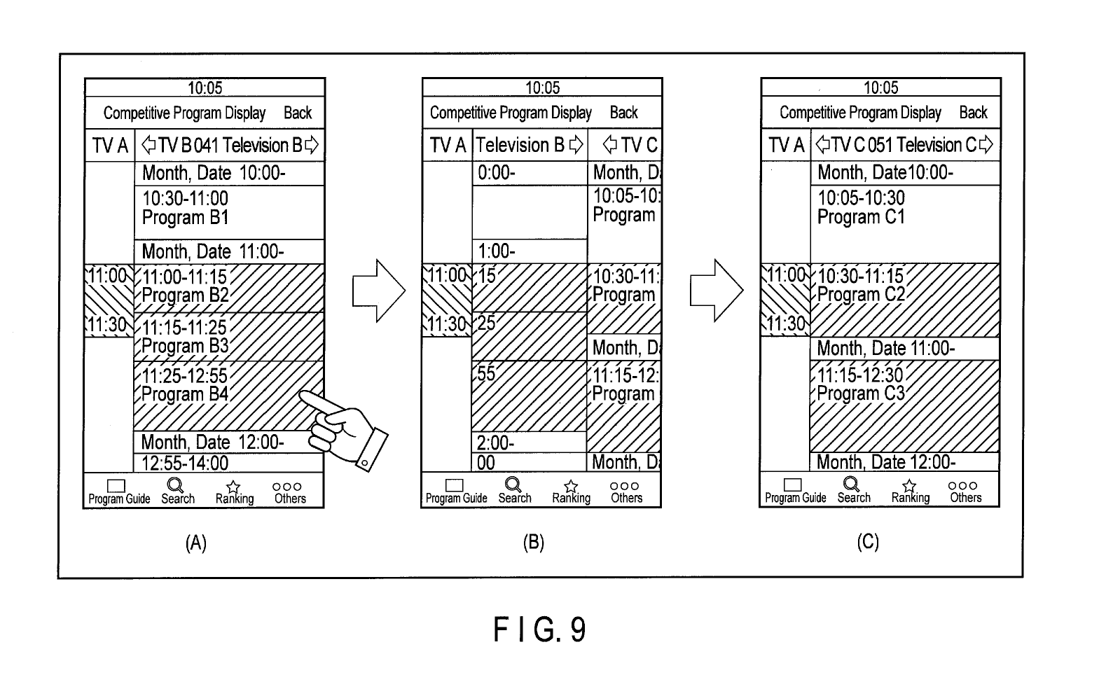

FIG. 9 is an exemplary second illustration showing the original GUI provided by the program information display application program 300 of the present embodiment. FIG. 9 shows an example of the shift of the display screen in the case where a horizontal swipe is performed in the overlapping program confirmation display. In FIG. 9, (A) shows a situation where a swipe is performed in the overlapping program confirmation display, (B) shows a situation where the program guide for the different channel displayed adjacent to the simplified program guide for the channel on which the focused program is scheduled to be broadcast is being switched to a program guide for a further different channel in response to the swipe, and (C) shows a situation where the program guide for the different channel displayed adjacent to the simplified program guide for the channel on which the focused program is scheduled to be broadcast has been switched to the program guide for the further different channel. As shown in FIGS. 9 (A) and (C), the air time of the focused program is constantly indicated by the simplified program guide displayed fixedly, for example, in the left periphery of the screen, and a program guide for each channel is displayed such that programs each having an air time overlapping the air time of the focused program are visually distinguishable.

The user can thereby easily confirm the programs (competitive programs) each having an air time overlapping that of the focused program when a program guide is displayed on the screen per channel and the display size of each object expressing a program in the program guide is variable according to a broadcast duration.

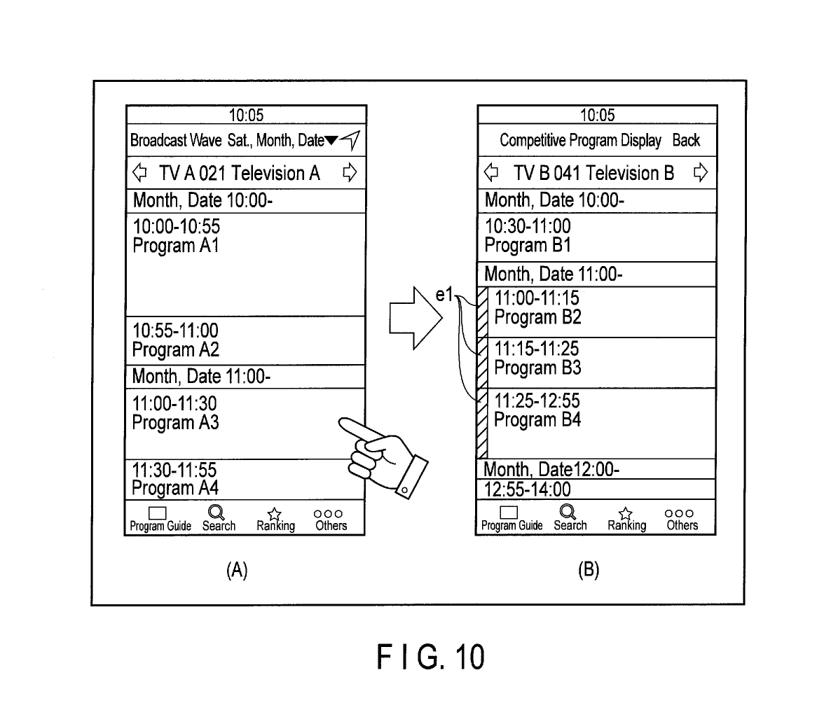

It should be noted that the simplified program guide for the channel on which the focused program is scheduled to be broadcast is not necessarily displayed in the overlapping program confirmation display. For example, if a long tap on an object expressing any program in the program guide is performed in the normal display as shown in FIG. 10 (A), only a program guide for a channel different from the channel on which the program expressed by the object, i.e., the focused program is scheduled to be broadcast may be displayed such that programs each having an air time overlapping that of the focused program are visually distinguishable by, for example, placing a mark e1 on these programs as shown in FIG. 10 (B). If the displayed channel is switched to a further different channel by a horizontal swipe, it is only necessary to display only a program guide for the further different channel such that programs each having an air time overlapping the air time of the focused program are visually distinguishable by, for example, placing a mark e1 on these programs.

In the above-described method, too, the user can easily confirm programs (competitive programs) each having an air time overlapping that of the focused program when a program guide is displayed on the screen per channel and the display size of each object expressing a program in the program guide is variable according to a broadcast duration, similarly to the method first described.

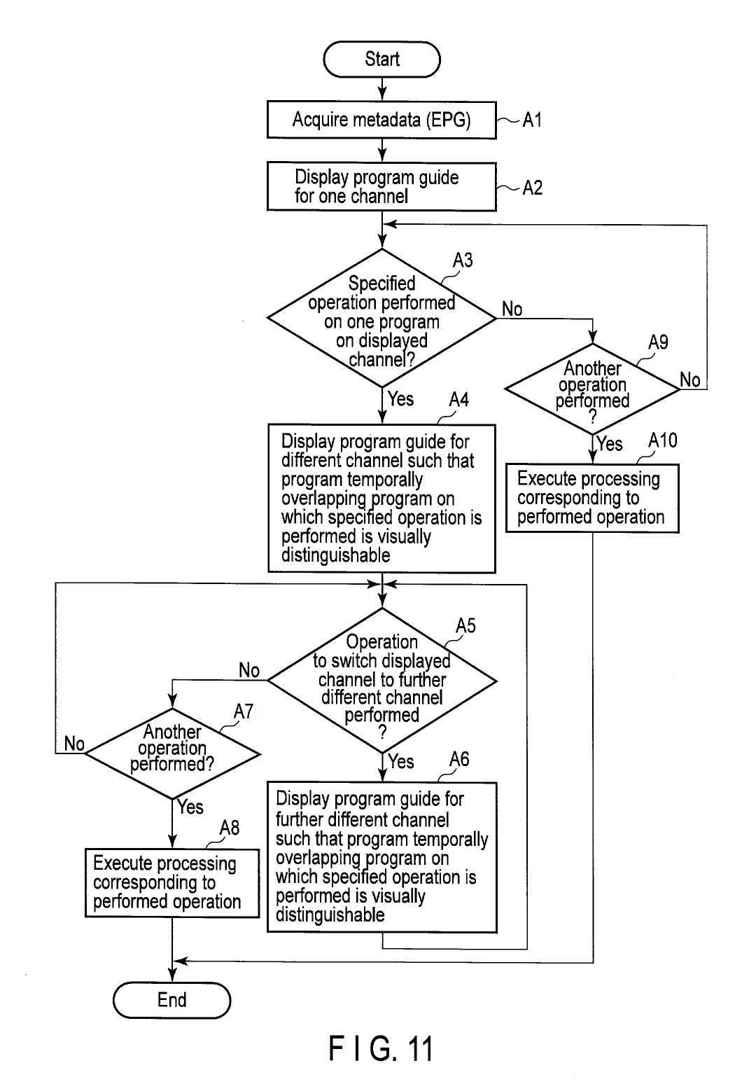

FIG. 11 is an exemplary flowchart showing an operating procedure of the program information display application program 300 which operates on the electronic device 1 of the present embodiment.

The program information display application program 300 acquires metadata from the metadata server (block A1). The program information display application program 300 displays a program guide for a channel by using the acquired metadata (block A2). If a specified operation is performed on a program of the displayed channel (YES in block A3), the program information display application program 300 displays a program guide for a different channel such that a program temporally overlapping the program on which the specified operation is performed is visually distinguishable (block A4).

Subsequently, if an operation to switch the displayed channel to a further different channel is performed (YES in block A5), the program information display application program 300 displays a program guide for the further different channel such that a program temporally overlapping the program on which the specified operation is performed is visually distinguishable (block A6). If another operation is performed (NO in block A5, YES in block A7), the program information display application program 300 executes processing corresponding to the performed operation (block A8).

If another operation is performed while displaying the program guide (NO in block A3, YES in block A9), the program information display application program 300 executes processing corresponding to the performed operation (block A10).

As described above, according to the electronic device 1 of the present embodiment, a visually recognizable program guide can be displayed on the relatively small screen.

### Second Embodiment

Next, a second embodiment is described.

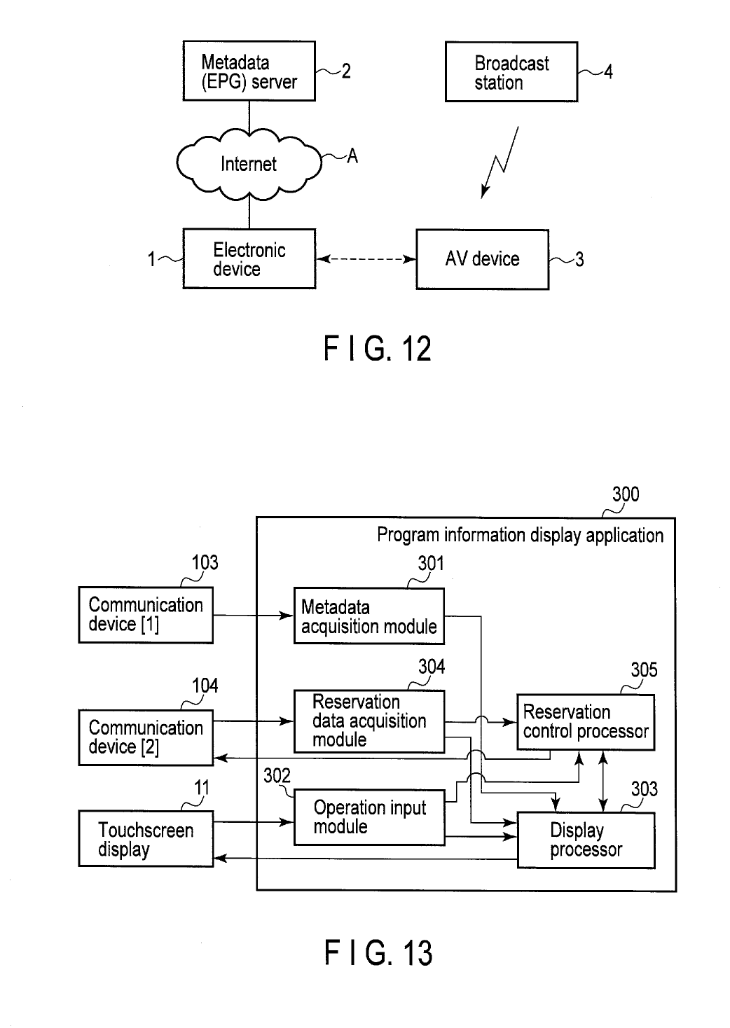

Similarly to the first embodiment, an electronic device of the present embodiment is implemented as, for example, a smartphone. FIG. 12 is an exemplary illustration showing an example of a use situation of the electronic device 1 in the present embodiment. Since the appearance and the system configuration of the electronic device 1 are the same as those of the electronic device of the first embodiment, their description is omitted. The same components as those of the electronic device of the first embodiment are represented by the same referende numbers and symbols.

The electronic device 1 can operate in cooperation with an audio and visual (AV) device 3 such as a television receiver and a recorder. More specifically, the electronic device 1 can serve as a remote controller of the AV device 3 that can receive television broadcast program data broadcast from the broadcast station 4. It is therefore assumed that the user uses the electronic device 1 at his/her house where the AV device 3 is installed. The electronic device 1 is configured to acquire information (reservation data) related to viewing or reservation of television broadcast programs from the AV device 3 and to display a visually recognizable program guide on a relatively small screen by using metadata acquired from the metadata server 2 and the reservation data acquired from the AV device 3.

FIG. 13 is an exemplary diagram showing a functional block of the program information display application program 300 which operates on the electronic device 1 of the present embodiment.

As shown in FIG. 13, the program information display application program 300 which operates on the electronic device 1 of the present embodiment comprises a reservation data acquisition module 304 and a reservation control processor 305 in addition to the configuration of the program information display application program 300 of the first embodiment.

The reservation data acquisition module 304 is a module that acquires reservation data from the cooperative AV device 3. The reservation control processor 305 is a module that executes processing for requesting the cooperative AV device 3 to reserve viewing or recording of television broadcast programs and requesting the cooperative AV device 3 to cancel the reservation of viewing or recording.

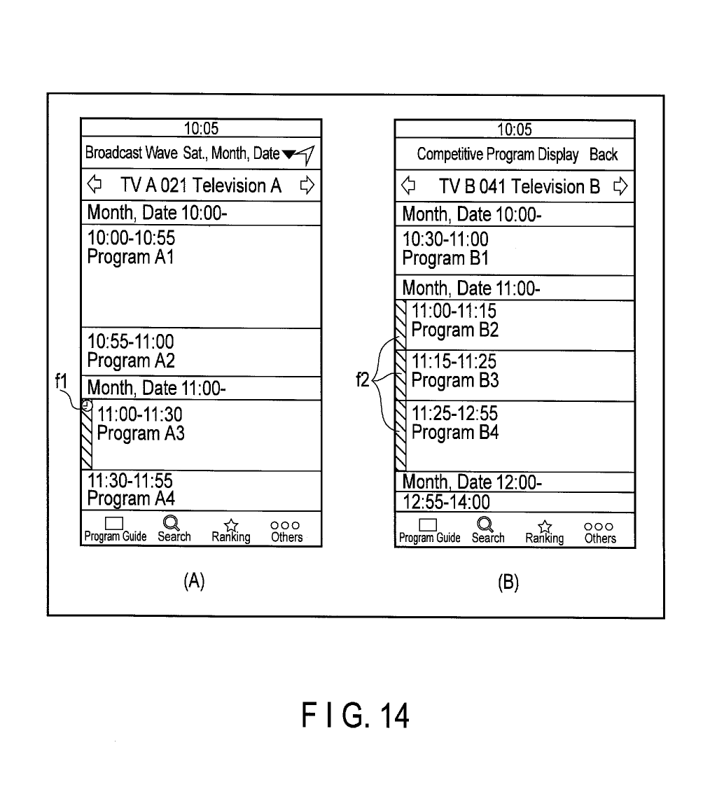

FIG. 14 shows an example of a program guide to television broadcast programs displayed by the program information display application program 300 of the present embodiment.

In FIG. 14, (A) shows a situation where a program guide for a channel on which a program whose viewing or recording is reserved is scheduled to be broadcast is displayed. A mark f1 indicates that viewing or recording is reserved. In the example illustrated, viewing or recording of a program A3 expressed by an object on which the mark f1 is placed is reserved in the AV device 3. That is, the display processor 303 of the present embodiment first determines, based on the reservation data acquired by the reservation data acquisition module 304, whether a program whose viewing or recording is reserved is present in a program guide to be displayed. If the program is present, the display processor 303 makes the program visually distinguishable.

In contrast, FIG. 14 (B) shows a situation where a program guide for a channel different from the channel on which the program (program A3) whose viewing or recording is reserved is scheduled to be broadcast is displayed. In FIG. 14 (B), programs B2, B3 and B4 expressed by objects on which marks f2 are placed each have an air time overlapping that of the program A3 whose viewing or recording is reserved. That is, the display processor 303 of the present embodiment secondly determines, based on the reservation data acquired by the reservation data acquisition module 304, whether a program having an air time overlapping that of the program of the different channel whose viewing or recording is reserved is present in a program guide to be displayed. If the program is present, the display processor 303 makes the program visually distinguishable.

That is, in contrast to the first embodiment which allows the user to confirm a program having an air time overlapping that of a program that the user has focused on when viewing a program guide, the present embodiment allows the user to confirm a program having an air time overlapping that of a program whose viewing or recording is reserved in a cooperative AV device 3 by acquiring reservation data from the AV device 3.

The user can thereby view a program guide for each channel while confirming a program having an air time overlapping that of a program on a different channel whose viewing or recording is reserved.

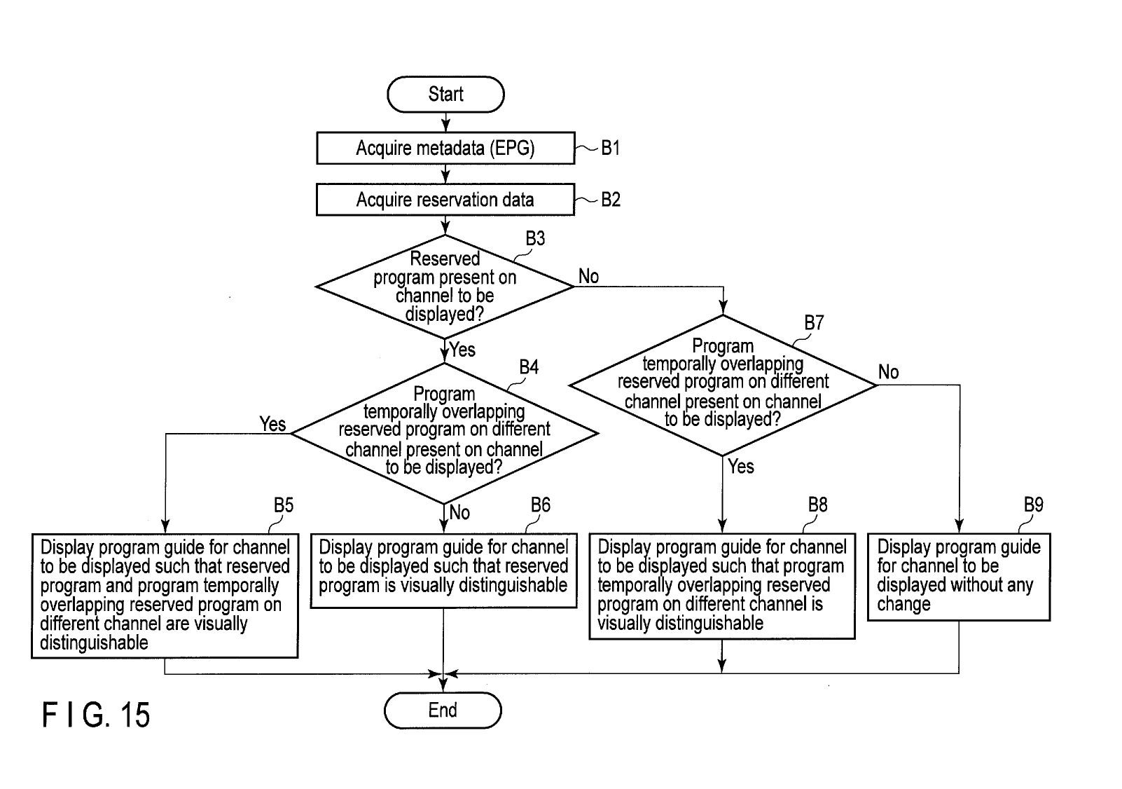

FIG. 15 is an exemplary flowchart showing an operating procedure of the program information display application program 300 which operates on the electronic device 1 of the present embodiment.

The program information display application program 300 acquires metadata from the metadata server (block B1). The program information display application program 300 also acquires reservation data from the cooperative AV device 3 (block B2). By using the acquired metadata and reservation data, the program information display application program 300 determines whether a reserved program is present in a channel to be displayed (block B3), and determines whether a program temporally overlapping a reserved program on a different channel is present in the channel to be displayed (block B4, block B7).

If a reserved program is present in the channel to be displayed (YES in block B3) and a program temporally overlapping a reserved program on a different channel is present (YES in block B4), the program information display application program 300 displays a program guide for the channel to be displayed such that the reserved program and the program temporally overlapping the reserved program of the different channel are visually distinguishable (block B5).

If a reserved program is present in the channel to be displayed (YES in block B3) and a program temporally overlapping a reserved program on a different channel is not present (NO in block B4), the program information display application program 300 displays a program guide for the channel to be displayed such that the reserved program is visually distinguishable (block B6).

If a reserved program is not present in the channel to be displayed (NO in block B3) and a program temporally overlapping a reserved program on a different channel is present (YES in block B7), the program information display application program 300 displays a program guide for the channel to be displayed such that the program temporally overlapping the reserved program of the different channel is visually distinguishable (block B8).

If a reserved program is not present in the channel to be displayed (NO in block B3) and a program temporally overlapping a reserved program on a different channel is not present (NO in block B7), the program information display application program 300 displays a program guide for the channel to be displayed without any change (block B9).

As described above, according to the electronic device 1 of the present embodiment, a visually recognizable program guide can be displayed on the relatively small screen.

### Third Embodiment

Next, a third embodiment is described.

Similarly to the first and second embodiments, an electronic device of the present embodiment is implemented as, for example, a smartphone. Since the appearance and the system configuration of the electronic device 1 are the same as those of the electronic device of the first embodiment and since a use situation of the electronic device 1 and the functional block of the program information display application program 300 which operates on the electronic device 1 are the same as those of the electronic device of the second embodiment, their description is omitted. The same components as those of the electronic devices of the first and second embodiments are represented by the same reference numbers and symbols.

The electronic device 1 can operate in cooperation with an AV device 3 such as a television receiver and a recorder. More specifically, the electronic device 1 can serve as a remote controller of the AV device 3 that can receive television broadcast program data broadcast from the broadcast station 4. It is therefore assumed that the user uses the electronic device 1 at his/her house where the AV device 3 is installed. The electronic device 1 is configured to acquire reservation data from the AV device 3 and further configured to visually recognizably perform operations related to reservation of television broadcast programs in the AV device 3 by using metadata acquired from the metadata server 2 and the reservation data acquired from the AV device 3.

Similarly to the first embodiment, the program information display application program 300 of the present embodiment first displays a program guide to television broadcast programs as shown in FIG. 7. It is assumed that the user viewing the program guide wants to reserve viewing or recording of a program in the program guide. In this case, the user performs a specified operation such as a long tap on an object expressing the program that the user has focused on. The specified operation is assumed to be a long tap.

If the information related to the touch operation input by the operation input module 302 indicates a long tap on an object expressing any program in the program guide, the display processor 303 displays a screen to reserve viewing or recording of the program.

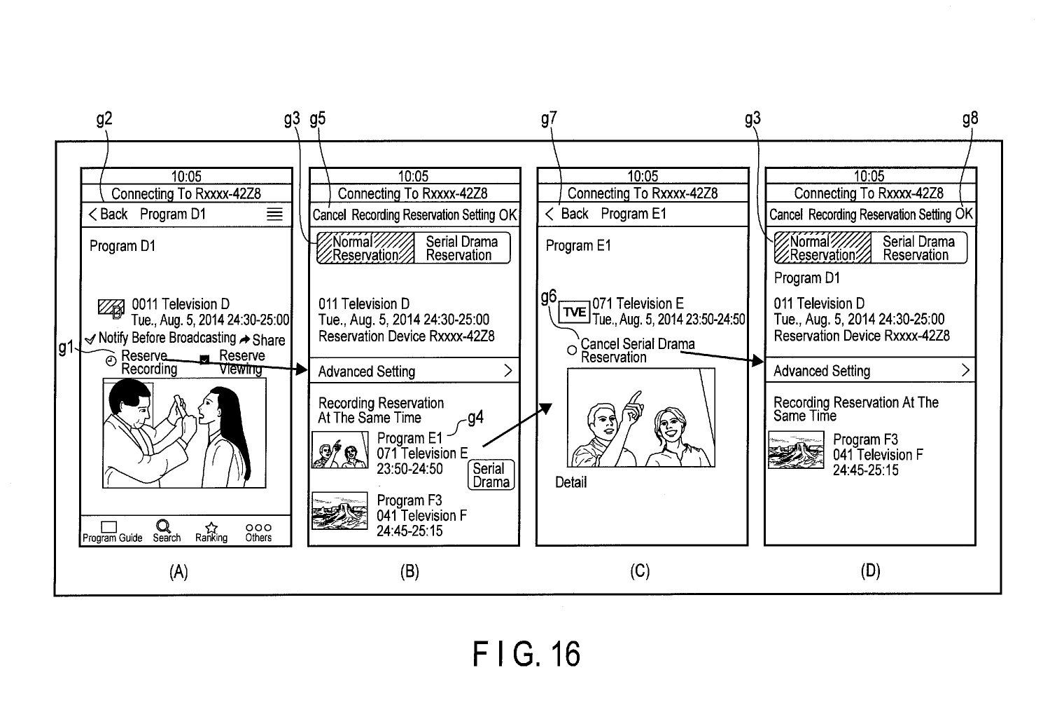

FIG. 16 is an exemplary illustration showing an original GUI provided by the program information display application program 300 of the present embodiment.

In FIG. 16, (A) shows a first screen displayed to reserve viewing or recording of the program expressed by the long-tapped object. The display processor 303 displays, on the first screen, detailed information related to the program included in the metadata acquired by the metadata acquisition module 301. In the example illustrated, a program D1 is the program expressed by the long-tapped object. If the user views the detailed information displayed on the first screen and wants to reserve recording of the program D1, the user taps a display area g1 of the character string “Reserve Recording”. If the user does not reserve recording of the program D1, the program guide can be displayed again by tapping a display area g2 of the character string “Back”.

If the information related to the touch operation input by the operation input module 302 indicates a tap on the display area of the character string “Reserve Recording”, the display processor 303 displays a second screen shown in FIG. 16 (B) by using the metadata acquired by the metadata acquisition module 301 and the reservation data acquired by the reservation data acquisition module 304. Since the reservation data indicates a program on a different channel whose recording has been already reserved and whose air time overlaps that of the program whose recording the user wants to reserve, the display processor 303 displays simplified information related to the program whose recording has been already reserved included in the metadata, along with simplified information related to the program D1 whose recording the user wants to reserve. It should be noted that the AV device 3 which cooperates with the electronic device 1 is assumed to be equipped with two tuners such that two programs are recorded at the same time. It should also be noted that reservation of recording has higher priority than reservation of viewing and a program whose viewing is reserved is not considered in the present embodiment.

In the example of FIG. 16 (B), recording of two programs (programs E1 and F3) overlapping the air time of the program D1 has been already reserved. The user views simplified information related to the program D1 whose recording the user wants to reserve and simplified information related to the programs E1 and F3 whose recording has been already reserved, and can thereby understand that the air times of the three programs overlap each other from 24:45 to 24:50. That is, the user can understand that recording of the program D1 cannot be reserved. If a normal reservation button g3 is tapped, the reservation control processor 305 notifies the AV device 3 of a request to reserve recording of the program D1. Normal reservation means one-time reservation. Serial drama reservation means successive reservation of a program that has the same title and is broadcast on a channel in the same period on the same day every week.

It is assumed that the user wants to cancel the recording reservation of the program E1 and reserve recording of the program D1. In this case, the user taps a display area g4 of the simplified information related to the program E1. The recording reservation of the program E1 is assumed to be the serial drama reservation. If the user does not reserve recording of the program D1, the user taps a display area g5 of the character string “Cancel” such that the program guide is displayed again.

If the information related to the touch operation input by the operation input module 302 indicates a tap on the display area of the simplified information related to the program E1, the display processor 303 displays a third screen to cancel recording reservation shown in FIG. 6 (C) by using the metadata acquired by the metadata acquisition module 301. The display processor 303 displays, on the third screen, detailed information related to the program E1 whose recording reservation the user wants to cancel. If the user views the detailed information displayed on the third screen and wants to cancel the recording reservation of the program E1, the user taps a display area g6 of the character string “Cancel Serial Drama Reservation”. Since the recording reservation of the program E1 is assumed to be the serial drama reservation as described above, the character string “Cancel Serial Drama Reservation” is displayed. If the recording reservation of the program E1 is the normal reservation, a character string “Cancel Normal Reservation” is displayed. If the user wants to cancel the recording reservation of the program F3 instead of the program E1, the screen shown in FIG. 16 (B) can be displayed again by tapping a display area g7 of the character string “Back”.

If the information related to the touch operation input by the operation input module 302 indicates a tap on the display area of the character string “Cancel Serial Drama Reservation”, the reservation control processor 305 notifies the AV device 3 of a request to cancel the recording reservation of the program E1. If the reservation control processor 305 receives notification that the cancel of the recording reservation of the program E1 is completed from the AV device 3, the reservation control processor 305 notifies the display processor 303 that the cancel of the recording reservation of the program E1 is completed. After receiving the notification, the display processor 303 displays a screen obtained by deleting the detailed information related to the program E1 from the screen of FIG. 16 (B), as shown in FIG. 16 (D). The user views the screen and can thereby confirm that recording of the program D1 can be reserved. The user taps the normal reservation button g3 to reserve recording of the program D1. After the recording is reserved, the program guide can be displayed again by tapping a display area g8 of the character string “OK”.

As described above, the electronic device 1 of the present embodiment provides a GUI that allows the user to confirm, when the user wants to reserve recording of a program in a cooperative AV device 3, a program temporally overlapping the program and to cancel the recording reservation through the screen to reserve recording of the program. The electronic device 1 of the present embodiment can thereby assist management of recording reservation in the AV device 3 which has the limited number of tuners.

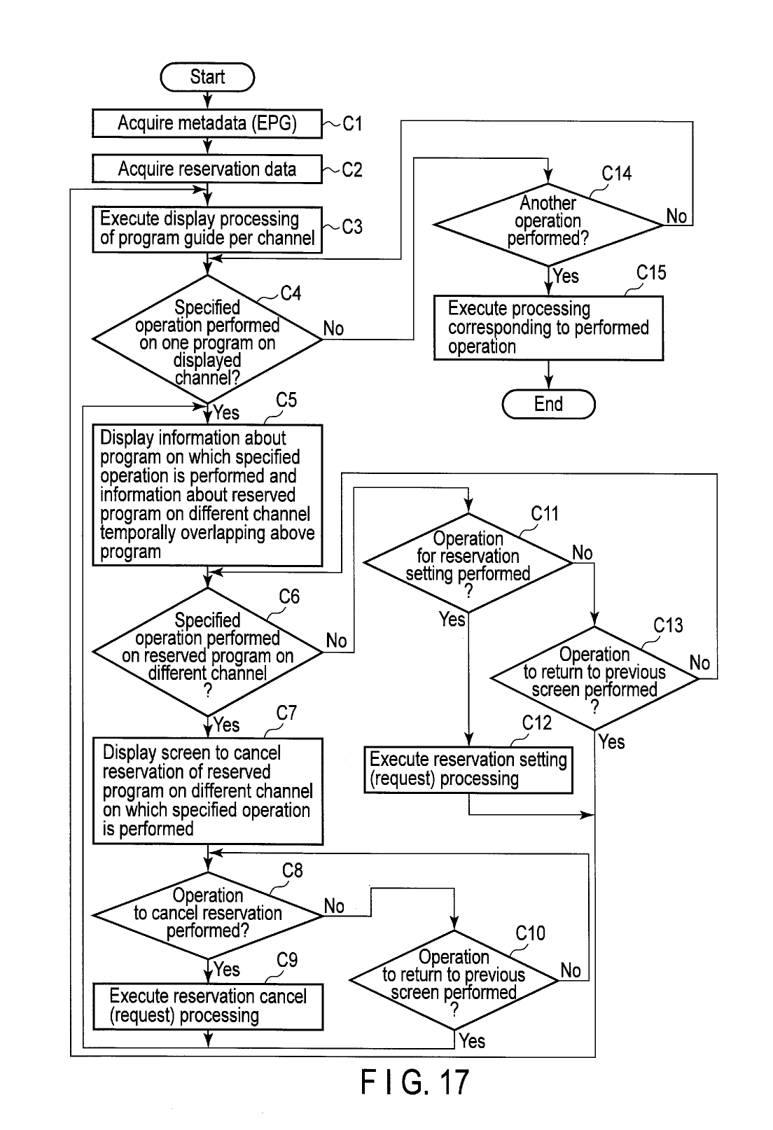

FIG. 17 is an exemplary flowchart showing an operating procedure of the program information display application program 300 which operates on the electronic device 1 of the present embodiment.

The program information display application program 300 acquires metadata from the metadata server (block C1). The program information display application program 300 also acquires reservation data from the cooperative AV device 3 (block C2). The program information display application program 300 first executes display processing of a program guide per channel by using the acquired metadata and reservation data (block C3).

If a specified operation is performed on a program of the displayed channel (YES in block C4), the program information display application program 300 displays information related to the program on which the specified operation is performed and information related to a reserved program on a different channel temporally overlapping the program (block C5). Subsequently, if a specified operation is performed on the reserved program of the different channel (YES in block C6), the program information display application program 300 displays a screen to cancel the reservation of the reserved program of the different channel on which the specified operation is performed (block C7). If an operation to cancel the reservation is performed on the displayed screen (YES in block C8), the program information display application program 300 executes processing for canceling the reservation of the program (block C9). If the cancel of the reservation is completed, the program information display application program 300 executes the display processing of block C5 again. If an operation to return to the previous screen is performed (NO in block C8, YES in block C10), the program information display application program 300 executes the display processing of block C5 again without executing the reservation cancel processing of block C9.

If an operation for reservation setting of the program on which the specified operation is performed in the program guide is performed (NO in block C6, YES in block C11), the program information display application program 300 executes processing for reservation setting of the program (block C12). After the reservation setting is completed, the program information display application program 300 executes the display processing of block C3 again. If an operation to return to the previous screen is performed (NO in block C11, YES in block C13), the program information display application program 300 executes the display processing of block C3 again without executing the reservation setting processing of block C12.

If another operation is performed while displaying the program guide (NO in block C4, YES in block C14), the program information display application program 300 executes processing corresponding to the performed operation (block C15).

As described above, according to the electronic device 1 of the present embodiment, a visually recognizable program guide can be displayed on the relatively small screen in conjunction with reservation of viewing or recording of a program or cancel of the reservation.

Various functions described in the present embodiment may be implemented by a processing circuit. Examples of the processing circuit include a programmed processor such as a central processing unit (CPU). The processor executes each of the described functions by executing a program stored in a memory. The processor may be a microprocessor including an electric circuit. Examples of the processing circuit also include a digital signal processor (DSP), an application specific integrated circuit (ASIC), a microcontroller, a controller and other electric circuit components.

Since each of the steps of the present embodiment can be executed by a computer program, the same advantage as the present embodiment can be easily achieved by installing the computer program on a general-purpose computer through a computer-readable storage medium that stores the computer program and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display;
a receiver configured to receive information related to programs on at least two channels; and
a processor configured to switch a first program guide displayed on the display to a second program guide, the first program guide including a plurality of first objects, and the second program guide including a plurality of second objects,
wherein the plurality of first objects comprises information related to a plurality of programs on the first channel, and a display size of the plurality of first objects is based on broadcast durations of the plurality of programs on the first channel,
wherein the plurality of second objects comprises information related to a plurality of programs on the second channel, and a display size of the plurality of second objects is based on broadcast durations of the plurality of programs on the second channel,
wherein the display size of at least one of the plurality of first objects differs from the display size of at least one of the plurality of second objects for the same broadcast duration,
wherein when the second program guide is displayed and when one of the plurality of first objects is selected from the first program guide, at least one of the plurality of programs on the second channel in the second program guide comprising a broadcast time that overlaps a broadcast time of a program corresponding to the selected first object is displayed visually differently.

2. The electronic device of claim 1, wherein:
when the second program guide is displayed and when one of the plurality of first objects is selected from the first program guide, the processor is further configured to display a fourth object adjacent to the second program guide, the fourth object comprising at least information related to the program corresponding to the selected first object and located at a position defined based on the broadcast time of the program corresponding to the selected first object;
when an operation is performed to switch displaying to a third program guide for a third channel different from the first channel and the second channel from the fourth object and the second program guide being displayed, the processor is configured to display the third program guide replacing the second program guide while continuously displaying the fourth object,
wherein the third program guide includes a plurality of third objects, the plurality of third objects comprising information related to a plurality of programs, and a display size of the plurality of third objects defined based on broadcast durations of the plurality of programs; and
at least one of the plurality of programs in the third program guide overlapping in the broadcast time with the program corresponding to the selected first object is displayed differently.

3. The electronic device of claim 1, wherein when the second program guide is displayed and when one of the plurality of first objects in the first program guide is selected, a program entirely overlapping in broadcast time with the program corresponding to the selected first object and a program partially overlapping in broadcast time with the program corresponding to the selected first object are displayed differently.

4. The electronic device of claim 1, wherein:
the receiver is configured to receive information related to a reservation of viewing or recording of a program; and
the processor is configured to display a program guide for a channel overlapping in broadcast time with a reserved program on a different channel visually different.

5. The electronic device of claim 1, wherein:
the receiver is configured to receive information related to the reservation of viewing or recording of a program;
when a program is selected in the first program guide or in the second program guide displayed by selecting one of the plurality of first objects, the processor is configured to display a first screen for the reservation of viewing or recording of the selected program and for showing information related to the selected program;
when an operation is performed to reserve a recording of the selected program in the first screen, the processor is configured to display a second screen for the reservation of recording of the selected program and for showing information related to the selected program and information related to a program on a different channel which overlaps in broadcast time with the selected program for which a recording is reserved; and
when the program of the different channel shown in the second screen is selected, the processor is configured to display a third screen for cancellation of recording the reservation of the program of the different channel.

6. A method for an electronic device, the method comprising:
receiving information related to programs on at least two channels; and
switching a first program guide displayed on a display to a second program guide, the first program guide including a plurality of first objects, and the second program guide including a plurality of second objects,
wherein the plurality of first objects comprises information related to a plurality of programs on the first channel, the information including a display size information based on broadcast durations of the plurality of programs on the first channel,
wherein a plurality of second objects comprises information related to a plurality of programs on a second channel, the information including displaying a size information based on broadcast durations of the plurality of programs on the second channel,
wherein the display size of at least one of the plurality of first objects differs from the display size of at least one of the plurality of second objects for the same broadcast duration,
wherein when the second program guide is displayed and when one of the plurality of first objects is selected from the first program guide, at least one of the plurality of programs on the second channel in the second program guide comprising a broadcast time that overlaps a broadcast time of a program corresponding to the selected first object is displayed differently.

7. The method of claim 6, wherein:
when the second program guide is displayed and when one of the plurality of first objects is selected from the first program guide, a fourth object adjacent to the second program guide is displayed, the fourth object comprising at least information related to the program corresponding to the selected first object and located at a position based on the broadcast time of the program corresponding to the selected first object; and
when an operation is performed to switch displaying to a third program guide for a third channel different from the first channel and the second channel from the fourth object and the second program guide, displaying the third program guide replacing the second program guide while continuously displaying the fourth object, wherein:
the third program guide includes a plurality of third objects, the plurality of third objects comprising information related to a plurality of programs on the third channel, and a display size of the plurality of third objects based on broadcast durations of the plurality of the programs; and
at least one of the plurality of programs in the third program guide overlapping in the broadcast time with the program corresponding to the selected first object is visually different.

8. The method of claim 6, wherein when the second program guide is displayed and when one of the plurality of first objects in the first program guide is selected, a program entirely overlapping in broadcast time with the program corresponding to the selected first object and a program partially overlapping in broadcast time with the program corresponding to the selected first object are visually different.

9. The method of claim 6, further comprising:
receiving information related to a reservation of viewing or recording of a program; and
displaying a program guide for a channel overlapping in broadcast time with a reserved program on a different channel visually different.

10. The method of claim 6, further comprising:
receiving information related to the reservation of viewing or recording of a program;
when a program is selected in the first program guide or in the second program guide displayed by selecting one of the plurality of first objects, displaying a first screen for the reservation of viewing or recording of the selected program and for showing information related to the selected program;
when an operation is performed to reserve a recording of the selected program in the first screen, displaying a second screen for the reservation of recording of the selected program and for showing information related to the selected program and information related to a program on a different channel which overlaps in broadcast time with the selected program for which a recording is reserved; and
when the program of the different channel shown in the second screen is selected, displaying a third screen for cancellation of recording the reservation of the program of the different channel.

11. A non-transitory computer readable medium having stored thereon a computer program which is executable by a computer, the computer program controlling the computer to execute functions of:
receiving information related to programs on at least two channels; and
switching a first program guide displayed on a display to a second program guide, the first program guide including a plurality of first objects, and the second program guide including a plurality of second objects,
wherein the plurality of first objects comprises information related to a plurality of programs on the first channel, the information including a display size of information based on broadcast durations of the plurality of programs on the first channel,
wherein the plurality of second objects comprises information related to a plurality of programs on a second channel, the information including a display size information based on broadcast durations of the plurality of programs on the second channel,
wherein the display size of at least one of the plurality of first objects varies from the display size of at least one of the plurality of second objects for the same broadcast duration,
wherein when the second program guide is displayed and when one of the plurality of first objects is selected from the first program guide, at least one of the plurality of programs on the second channel in the second program guide comprising a broadcast time that overlaps a broadcast time of a program corresponding to the selected first object is displayed differently.

12. The medium of claim 11, the computer program further controlling the computer to execute functions of:
when the second program guide is displayed and when one of the plurality of first objects is selected from the first program guide, a fourth object adjacent to the second program guide, displaying the fourth object comprising at least information related to the program corresponding to the selected first object and located at a position based on the broadcast time of the program corresponding to the selected first object; and
when an operation is performed to switch displaying to a third program guide for a third channel different from the first channel and the second channel from the fourth object and the second program guide, displaying the third program guide replacing the second program guide while continuously displaying the fourth object, wherein:
the third program guide includes a plurality of third objects, the plurality of third objects comprising information related to a plurality of programs on the third channel, and a display size of the plurality of third objects based on broadcast durations of the programs on the third channel; and
at least one of the plurality of programs in the third program guide overlapping in the broadcast time with the program corresponding to the selected first object is displayed differently.

13. The medium of claim 11, wherein when the second program guide is displayed and when one of the plurality of first objects in the first program guide is selected, a program entirely overlapping in broadcast time with the program corresponding to the selected first object and a program partially overlapping in broadcast time with the program corresponding to the selected first object are visually different.

14. The medium of claim 11, the computer program further controlling the computer to execute functions of:
receiving information related to a reservation of viewing or recording of a program; and
displaying a program guide for a channel overlapping in broadcast time with a reserved program on a different channel is displayed differently.

15. The medium of claim 11, the computer program further controlling the computer to execute functions of:
receiving information related to the reservation of viewing or recording of a program;
when a program is selected in the first program guide or in the second program guide displayed by selecting one of the plurality of first objects, displaying a first screen for the reservation of viewing or recording of the selected program and for showing information related to the selected program;
when an operation is performed to reserve a recording of the selected program in the first screen, displaying a second screen for the reservation of recording of the selected program and for showing information related to the selected program and information related to a program on a different channel which overlaps in broadcast time with the selected program and for which a recording is reserved; and
when the program of the different channel in the second screen is selected, displaying a third screen for cancellation of recording the reservation of the program of the different channel.
